(19) United States
(12) Patent Application Publication
(10) Pub. No.: US 2012/0138414 A1
(43) Pub. Date: Jun. 7, 2012

(54) CONTROLLING APPARATUS FOR FAN CLUTCH'S RPM IN IDLE AND METHOD THEREOF

(75) Inventors: Byong Koog Son, Suwon-si (KR); Seon Min Lee, Hwasung-si (KR); Jaejin Lee, Incheon (KR)

(73) Assignees: Kia Motors Corporation, Seoul (KR); Hyundai Motor Company, Seoul (KR)

(21) Appl. No.: 13/183,037

(22) Filed: Jul. 14, 2011

(30) Foreign Application Priority Data
Dec. 7, 2010 (KR) 10-2010-0124358

(51) Int. Cl. F04D 27/00; F16D 25/12

(52) U.S. Cl. 192/85.63

(57) ABSTRACT

A control method for controlling an idle rotation speed of a fan clutch may include sensing an idle state of a cooling fan by comparing a coolant temperature with a predetermined operating temperature, inputting a rotation speed of the cooling fan and the coolant temperature to an engine control unit (ECU), outputting a valve control signal controlled by the coolant temperature and the rotation speed of the cooling fan in the ECU, inputting the valve control signal to a valve, and opening/closing the valve according to the valve control signal. An apparatus for applying the method may include the fan clutch which comprises a housing, a rotor, a cover, an oil chamber, a valve, an antirotation bracket connected to the fan clutch and transmitting data, and an ECU calculating the valve control signal.

### CROSS-REFERENCE TO RELATED APPLICATION

The present application claims priority of Korean Patent Application Number 10-2010-0124358 filed in the Korean Intellectual Property Office on Dec. 7, 2010, the entire contents of which application is incorporated herein for all purposes by this reference.

### BACKGROUND OF INVENTION

1. Field of Invention

The present invention relates to a control of the fan clutch idle rotation speed. More particularly, the present invention relates to a controlling apparatus and a method that improve the reaction speed and feedback-controls for the idle rotation speed of a cooling fan.

2. Description of Related Art

A hydraulic fan clutch which regulates rotation speed of cooling fan in order to keep the temperature of the coolant appropriate in a commercial engine is occasionally used. Recently, as a regulation for emission is reinforced, the optimum control of fan clutch is needed to get cooling performance and continuous demands for enhancement of fuel efficiency due to the increment of the engine radiant heat.

A fan clutch for vehicle engines generally, as shown in FIG. 1, includes a rotor 100 and a cover 300 equipped at a side of a housing 200 which is penetrated by a rotation axis, and includes an oil chamber 500 which stores oil in the housing 200. Hereinafter, the cover 300 and the housing 200 together will be named as a case 210. A separating wall 270 is formed between the oil chamber 500 and a rotor 100, and a valve 250 which penetrates through the separating wall 270 is formed. The valve 250 is operated by a solenoid valve 240, and oil in the oil chamber 500 is flowed in the operation chamber 400 by the opening/closing of the valve 250. The inflowed oil into the operation chamber 400 is circulated by reentering into the oil chamber 500 through a return hole 260. A viscous frictional force of fluid is formed between the rotor 100 and the housing 200 by the oil remained in the outmost of the operation chamber 400, and a wiper 280 which transfers a torque to the housing 200 is formed.

As shown in FIG. 3, while the cooling fan rotates in idle, the solenoid valve 240 is on, so the solenoid valve 240 is operated. After that, a control pin 290 is drawn by a spring 230 and the valve 250 connected with the control pin 290 is also drawn, so the valve 250 is closed. Then, rotor protrusions 110 and 120 are connected with cover protrusion 320 and housing protrusion 220 respectively. In other words, oil is not supplied into the operation chamber 400 in idle state. But, the cooling fan at this time rotates in idle, so predetermined oil is remained. A viscosity of the remained oil is high, so the remained oil provides shearing force between the wiper 280 formed at the outer of the housing 200 and the rotor 100. Finally, the housing 200 can be rotated. At this time, the housing 200 is shown in FIG. 2. The shearing force increases, as the wiper angle α increases.

Looking at the operation process of the conventional fan clutch, a valve closing signal into the fan clutch shuts off the inflow of oil into the operation chamber 400, and the oil in the operation chamber 400 is recovered into the oil chamber 500, and then the remained oil in the operation chamber 400 generates the shearing force between the rotor 100 and the housing 200 and controls the idle rotation of the cooling fan. If the temperature of the coolant is over 90 degrees Celsius, the rotation speed increases and lowers the temperature of the coolant, and if the temperature of the coolant is below 90 degrees Celsius, the cooling fan rotates in idle. When the cooling fan rotates in idle, rotating power is supplied by the shearing force of the wiper 280 rather than the shearing force of the cover protrusion 320 or the housing protrusion 220. However, the valve is kept closed, so the remained oil is not flowed in the oil chamber 500 and comes to stand still. Therefore, the cooling fan rotates in idle, and the rotation speed of the cooling fan reaches target rotation speed, and then the reaction speed, which is the speed for the rotation speed of cooling fan to reach the target rotation speed due to increment of coolant temperature, slows. The reason for the slowed reaction speed is that a fluid is generated by opening of the closed valve 250, so a lag phenomenon, which the fluid takes time to reach the steady state, created.

FIG. 4 is a graph showing an idle drop and a reaction speed. In FIG. 4, we can see that the rotation speed of an engine in sudden drop lowers the rotation speed of cooling fan as well as the reaction speed. In other words, in case that the idle rotation speed of cooling fan is 92 rpm, the difference of reaction speed between the target speed and the real speed of cooling fan is 94 seconds, and in case that the idle rotation speed of cooling fan is 190 rpm, the difference of those is 22 seconds. Also, if the idle rotation speed of cooling fan is reduced in order to enhance fuel efficiency, there is a risk of idle drop which the rotation speed of cooling fan drops to near zero. The idle rotation speed of cooling fan must be increased to prevent this, but there is a problem which the fuel efficiency is lowered in case of the increment of the idle rotation speed.

FIG. 5 is a graph showing the relationship between the rotation speed of cooling fan and target rotation speed according to the change for the rotation speed of an engine in related art. “A” in FIG. 5 shows that the rotation speed of cooling fan is lower than the target rotation speed as a case of low rpm and reaction speed is deteriorated. In addition it shows a risk in which the idle drop phenomenon can be generated. “B” in FIG. 5 shows a tendency that the rotation speed of cooling fan is subject to the rotation speed of the engine in sudden change of the rotation speed in engine, and it shows that starting property and accelerating performance are deteriorated. Also, “C” shows that the rotation speed of cooling fan gains on the engine speed in idle rotation of an engine, we can see that the fuel efficiency is deteriorated because of the unnecessary input of power, in case the rotation speed of cooling fan is equal to the engine speed.

As described above, the conventional target rotation speed keeps 400 rpm, but a problem is generated by varying the actual rotation speed of cooling fan continuously. If a diameter of a return hole 260 or the wiper angle α is enlarged in order to improve the reaction speed for the cooling performance, there is a problem that the idle rotation speed of the cooling fan becomes fast by fulfilling unnecessarily an inflow and an outflow of oil, so consumption power is increased by consuming the power more than needed. In addition, because the idle rotation speed have to be kept fast in order to prevent the idle drop phenomenon, there is a problem that the fuel efficiency goes bad.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention have been made in an effort to provide a control apparatus for idle rotation speed of fan clutch and a method thereof having advantages of improving a reaction speed through a control for the opening/closing speed of a valve by flowing oil in operation chamber at all times and simultaneously inputting the valve control signal which is output by a feedback control to a fan clutch, and preventing an idle drop phenomenon.

Various aspects of the present invention are directed to provide a control method for controlling the idle rotation speed of fan clutch which rotates in idle according to the relationship between the temperature of coolant and the operating temperature. Exemplary control methods of the present invention may comprise: sensing idle state of cooling fan by comparing the coolant temperature with the predetermined operating temperature; inputting the rotation speed of cooling fan and the coolant temperature to an engine control unit (ECU); outputting a valve control signal controlled by the coolant temperature and the rotation speed of cooling fan in ECU; inputting the valve control signal to the valve; opening/closing the valve according to the valve control signal.

The valve control signal outputting may further comprise: calculating the target rotation speed of cooling fan in ECU by comparing the coolant temperature with the operating temperature of coolant; and calculating the valve control signal by the difference of the calculated target rotation speed of cooling fan and the input rotation speed of cooling fan.

The operating temperature according to exemplary control methods of the present invention may be determined by a highest temperature of coolant, a reaction speed and a ascension rate of coolant temperature. The inflow and withdrawal of oil according to exemplary apparatuses and methods of the present invention can be easily done by adjusting a wiper angle formed in a housing of fan clutch or a diameter for a return hole.

Various aspects of the present invention are also directed to provide a control apparatus for controlling the idle rotation speed of fan clutch. Exemplary control apparatuses of the present invention may comprise: a fan clutch comprising a housing, a rotor and a cover formed at a side of the housing and an oil chamber formed in the housing and storing oil; an antirotation bracket connected to the fan clutch and transmitting various data; an ECU calculating a valve control signal according to the input data from the antirotation bracket, an engine speed and a coolant temperature. The ECU outputs the valve control signal by control map according to the rotation speed of cooling fan. The inflow and withdrawal of oil in the above exemplary apparatuses can be easily done by adjusting a wiper angle formed in a housing of fan clutch or a diameter for a return hole.

As described above, Various features of the present invention are directed to address or improve the reaction speed by adjusting the throttle opening in order for oil to flow in the operation chamber of fan clutch and also improve a cooling performance. In addition, a consumed power can be lowered by reducing the idle rotation speed, and a vehicle fuel efficiency, starting properties and an acceleration performance can be improved, and the noise of fan clutch can be reduced, and an idle drop phenomenon can be prevented, and fuel efficiency can be improved by raising the operating temperature of cooling fan.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a partial cut-away perspective view of a fan clutch.

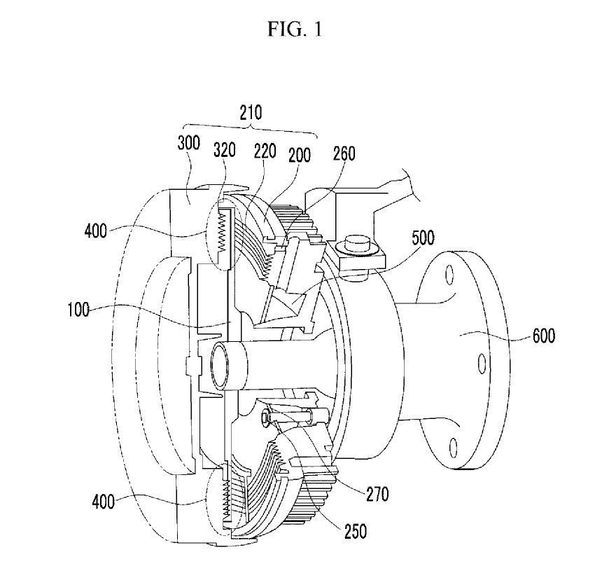

FIG. 2 is a cross-sectional view of wiper in a fan clutch.

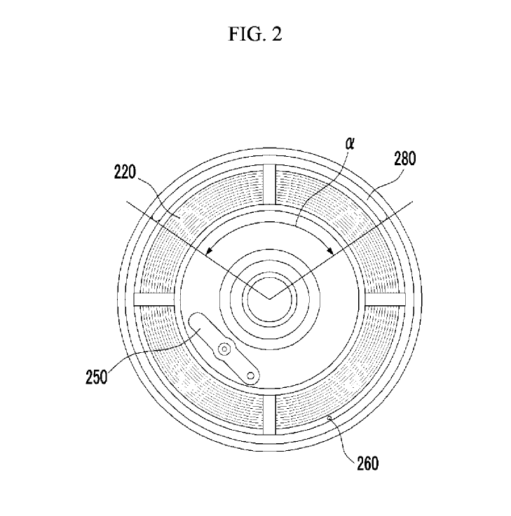

FIG. 3 is a detailed cross-sectional view of a fan clutch.

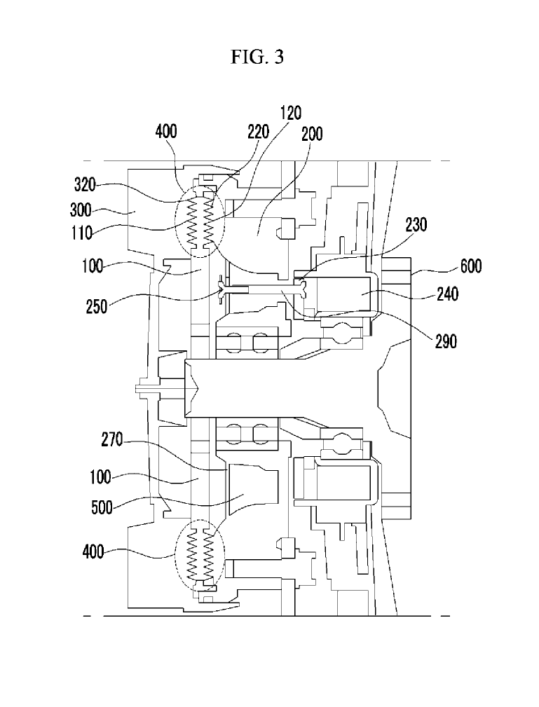

FIG. 4 is a graph showing the relation of a conventional idle drop and a reaction speed.

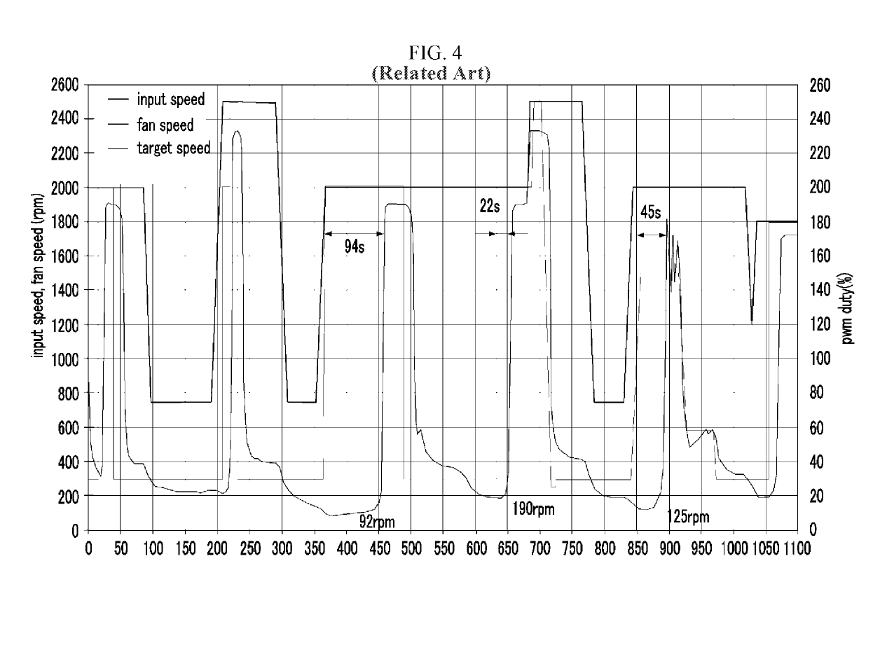

FIG. 5 is a graph showing that a conventional engine speed follows the rotation speed of cooling fan.

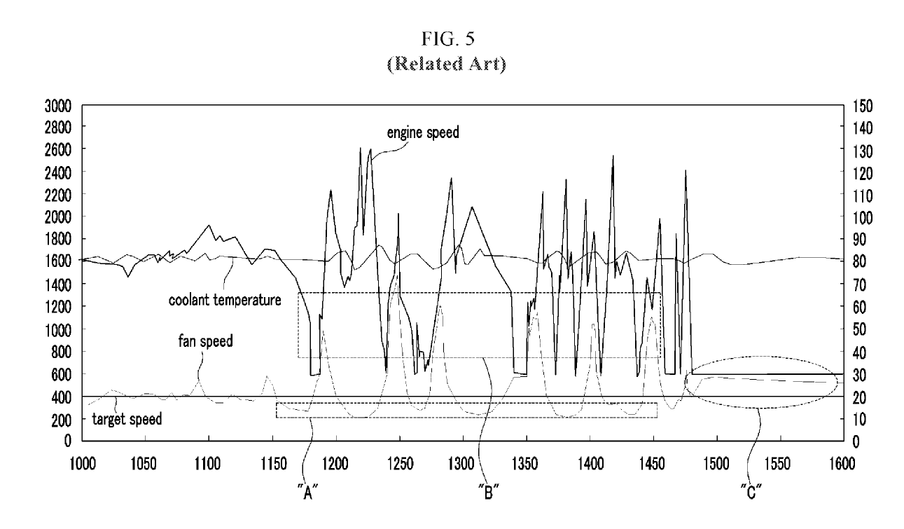

FIG. 6 is a graph showing the reaction speed according to exemplary controlling apparatuses of the present invention.

FIG. 7 is a graph showing an engine speed and the rotation speed of cooling fan according to exemplary controlling apparatuses of the present invention.

FIG. 8 is a flowchart of control operations for the cooling fan in idle according to exemplary controlling apparatuses of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

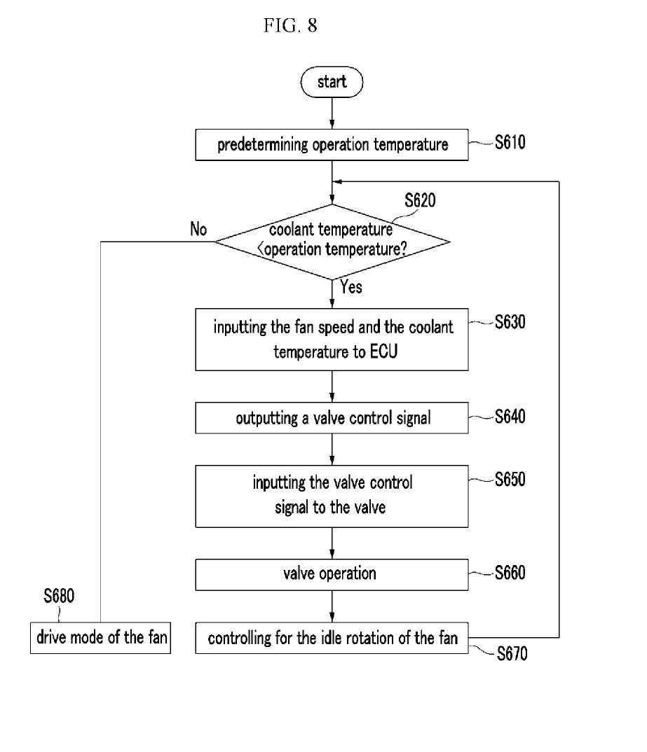

If a cooling fan does not rotate in idle but is in a state cooling a coolant by operating a cooling fan, the cooling fan is controlled by the drive mode at S680 as shown in FIG. 8. The operation in the drive mode is similar to the conventional control method.

Therefore, the cooling fan must be firstly sensed if the cooling fan rotates in idle. This is sensed by an engine control unit (ECU). That is, if a coolant temperature is higher than an operating temperature after the coolant temperature is compared with a predetermined operating temperature at S610, a mode is converted into a cooling fan drive mode, so the coolant is cooled. And if the coolant temperature is lower than the operating temperature, the cooling fan is sensed in idle rotation of cooling fan at S620. The cooling fan drive mode will not be described in the present invention because that follows a conventional method.

The operating temperature is determined by a maximum temperature of coolant, a reaction speed and an ascension rate of coolant temperature. The maximum temperature of coolant means an admitted maximum temperature of coolant in an engine. For example, if the admitted maximum temperature of coolant is 110 degrees Celsius, the coolant operating temperature can be over the 110 degrees Celsius.

And, if the reaction speed is fast, the operating temperature can be raised. In spite of slow cooling, a fast reaction speed provides some extra time for cooling. But if the reaction speed is slow, the coolant must be cooled by setting a low operating temperature of coolant.

Also, the operating temperature is set differently according to the ascension rate of coolant temperature. The operating temperature is usually set by the ascension rate of coolant in summer than in winter because conditions in summer are worse.

Then, if the ascension rate of coolant temperature is high, the operating temperature must be lowered for the same reaction speed; and if the ascension rate of coolant temperature is low, the operating temperature may be set in a higher temperature.

If the coolant temperature is lower than the operating temperature, the cooling fan rotates in idle. The idle rotation of cooling fan means that the cooling fan rotates when the cooling temperature is lower than the operating temperature. That is, it means that the cooling fan does not rotate for cooling the coolant but just rotates by a viscous frictional force of oil, so the cooling fan rotates continuously in a lower speed compared with the speed in cooling fan drive mode.

Oil is continuously fed to an operation chamber 400 by controlling the opening/closing speed of the valve 250 in the present invention, and the valve 250 is opened thereby, so the reaction time can be minimized by minimizing the time which reaches the steady state. The valve control signal has to be inputted in order to control the opening/closing speed of the valve 250.

The valve control signal is outputted from an ECU to the fan clutch. The processes of inputting the output valve control signal to the fan clutch will be hereinafter described.

Refer to FIG. 8. First, the operating temperature is set in the ECU. If a measured coolant temperature is lower than the predetermined operating temperature of the coolant, the cooling fan rotates in idle. The coolant temperature and the rotation speed of cooling fan are inputted into the ECU after being monitored at S630.

The input coolant temperature is compared with the operating temperature in the ECU, and then the target rotation speed of cooling fan is determined so that the cooling fan can rotate in idle in a state where the coolant temperature is lower than the operating temperature.

The setting of the target rotation speed for the cooling fan is fulfilled by a proportional integral (PI) control method. For example, if the coolant temperature is lower than the operating temperature, the target rotation speed of the cooling fan may be set at a pre-determined value, preferably 300 rpm. If the coolant temperature is higher than the operating temperature, the target rotation speed of the cooling fan may be set at a different rotation speed.

The valve control signal is outputted at S 640 by PI control based on the difference of the input rotation speed of cooling fan in ECU and the target rotation speed. The valve control signal can be zero to 100 percent. For example, if the valve control signal is 70%, it means that the valve 250 opens and closes 70 times per second.

The valve control signal controls the opening/closing the valve 250, and oil circulates through the operation chamber 400 and the oil chamber 500. By circulating oil continuously, the reaction speed can be improved since the time for oil flow to reach the steady state can be reduced.

The output valve control is inputted to the valve 250 of fan clutch after outputting the valve control signal at S650. If the valve control signal is inputted to the valve 250, the valve 250 operates opening and closing according to the input value at S660.

The reaction speed of the valve 250 by the above process can be improved by circulating oil in idle rotation state in the fan clutch, so the idle rotation of cooling fan can be controlled at S670.

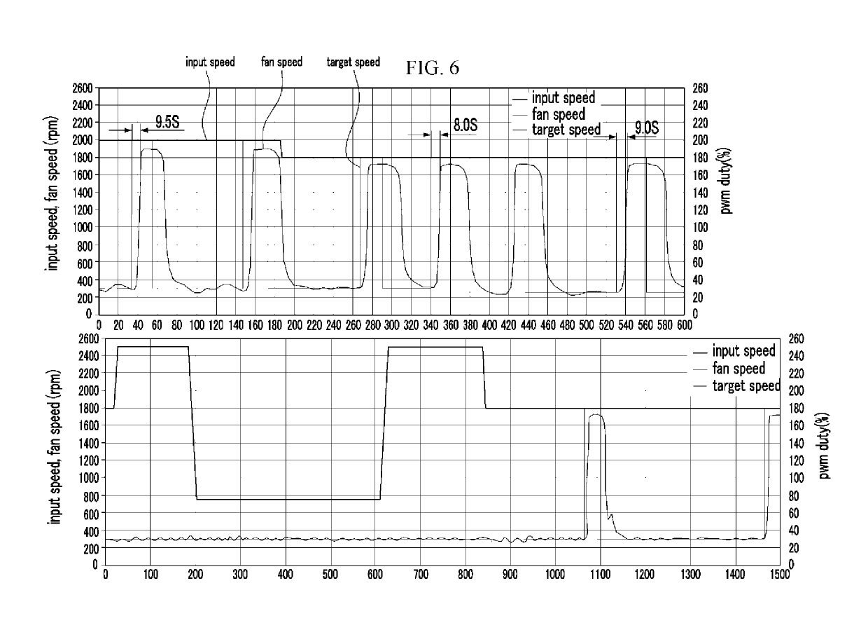

If the idle rotation of the cooling fan is controlled in this way, the reaction speed, as shown in FIG. 6, can be improved. That is, the reaction speed can be shortened by 9.5 seconds. Also, the rotation speed is stable in spite of sudden drop of engine speed, and the idle rotation speed of cooling fan can be controlled in accordance with the target rotation speed.

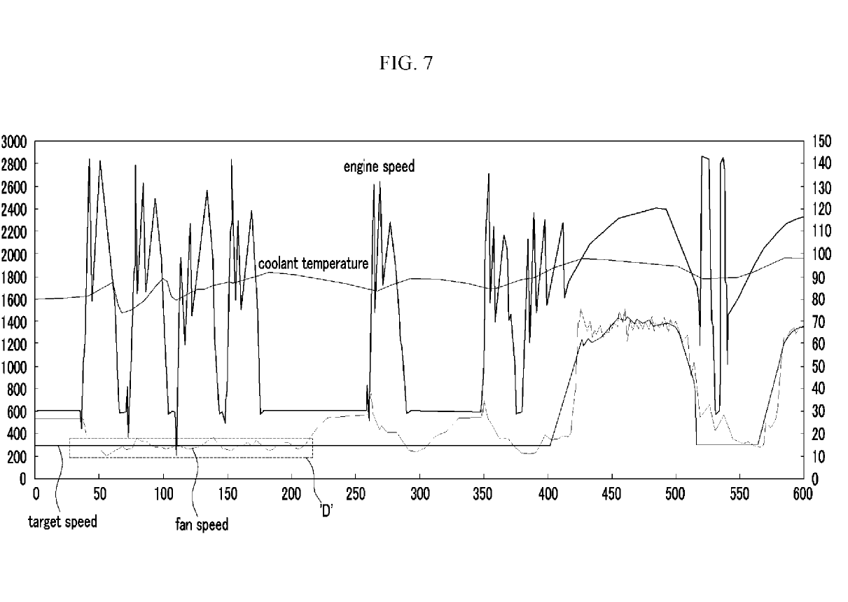

In addition, when the target rotation speed is set, as shown in FIG. 7, at 300 rpm during the idle rotation of cooling fan, the real rotation speed of cooling fan can be controlled stably in accordance with the target rotation speed without idle drop phenomenon of cooling fan and this is confirmed in “D”.

Moreover, the coolant temperature, which is a little below 100 degrees Celsius, is higher than the conventional operating temperature 90 degrees Celsius. That is the reason why the performance of which the engine speed follows the rotation speed of cooling fan is improved in spite of the rapid change of engine speed.

Also, the inflow or the recovery of oil can be easily adjusted by making the wiper angle α formed in the housing of fan clutch smaller or increasing the diameter of return hole 260. However, the flow of oil becomes easy by enlarging the diameter of the return hole 260, a passage for oil flow, instead of downsizing the wiper angle α.

Other aspects of the present invention are directed to provide an apparatus for controlling the idle rotation speed of fan clutch. Exemplary apparatuses may include a housing 200, a rotor 100 and a cover 300 formed at a side of the housing 200, a fan clutch including an oil chamber 500 formed in the housing 200 and storing oil, an anti-rotation bracket transmitting various data and connected to the fan clutch, an ECU calculating and outputting the valve control signal from the data inputted from the anti-rotation bracket, engine speed, and coolant temperature.

The anti-rotation bracket is an apparatus connecting the fan clutch and the ECU.

The ECU outputs the valve control signal by control map according to the predetermined rotation speed of cooling fan, and the control of wiper angle α formed in the fan clutch housing 300 or the control for the diameter of return hole 260 which makes the inflow or the recovery of oil easy.

That is, the valve control signal transferred according to the predetermined logic based on monitoring the coolant temperature, the rotation speed of cooling fan and the engine speed etc. in ECU controls the rotation speed of cooling fan.

As seen above, the cooling performance according to the exemplary embodiments of the present invention can be improved by enhancing the reaction speed of the valve 250.

The idle rotation was subordinate to the engine speed in the past years, but the idle rotation of cooling fan in the present invention is not subordinate to the engine speed and the power consumed for driving the fan clutch is decreased by reducing the rotation speed stably.

By this, the fuel efficiency can be improved by about 5%, and starting properties and accelerating performance can be improved. In addition, the rotation speed of cooling fan is reduced, so noise of the cooling fan can be reduced.

Also, the operating temperature of the cooling fan is increased by increasing the reaction speed and the fuel efficiency can be improved thereby. In other words, the operating temperature of the cooling fan was about 90 degrees Celsius in the past, but it is about 94 degrees Celsius in exemplary embodiments of the present invention, so the fuel efficiency can be improved because it is not necessary to operate the cooling fan by the difference of the temperatures.

For convenience in explanation and accurate definition in the appended claims, “lower” and other terms are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the claims appended hereto and their equivalents.

What is claimed is:

1. A control method for controlling an idle rotation speed of a fan clutch, the control method comprising:
sensing an idle state of a cooling fan by comparing a coolant temperature with a predetermined operating temperature;
inputting a rotation speed of the cooling fan and the coolant temperature to an engine control unit (ECU);
outputting a valve control signal controlled by the coolant temperature and the rotation speed of the cooling fan in the ECU;
inputting the valve control signal to a valve; and
opening/closing the valve according to the valve control signal.

2. The method of claim 1, wherein outputting the valve control signal comprises:
calculating a target rotation speed of the cooling fan in the ECU by comparing the coolant temperature with the predetermined operating temperature of coolant; and
calculating the valve control signal based on the difference of the calculated target rotation speed of the cooling fan and the input rotation speed of the cooling fan.

3. The method of claim 2, wherein the valve control signal can be a value between 0 to 100 percent.

4. The method of claim 3, wherein the valve control signal controls a number of times the valve opens and closes per second.

5. The method of claim 1, wherein the predetermined operating temperature may be determined by a maximum temperature of a coolant, a reaction speed and an ascension rate of the coolant temperature.

6. An apparatus for applying the method of claim 1, comprising:
the fan clutch which comprises a housing, a rotor and a cover formed at a side of the housing, an oil chamber formed in the housing and storing an oil, and the valve;
an antirotation bracket connected to the fan clutch and transmitting data;
the ECU calculating the valve control signal according to the input data from the antirotation bracket, an engine speed and the coolant temperature.

7. The apparatus of claim 6, wherein the ECU outputs the valve control signal by a control map according to the rotation speed of the cooling fan.

8. The apparatus of claim 6, wherein an inflow and a withdrawal of the oil may be conducted by adjusting a wiper angle formed in the housing of the fan clutch or a diameter of a return hole formed also in the housing of the fan clutch.

9. The apparatus of claim 6, wherein the valve may be opened/closed according to the valve control signal such that the oil can be circulated continuously to improve a reaction speed.
